(19) United States
(12) Patent Application Publication
(10) Pub. No.: US 2013/0253996 A1
(43) Pub. Date: Sep. 26, 2013

(54) PASSENGER WAITING SYSTEM AND METHOD THEREOF

(71) Applicants: MITAC INTERNATIONAL CORP., Taoyuan County (TW); MITAC COMPUTER (SHUN DE) LTD., Foshan City (CN)

(72) Inventor: Meng SINGLE, Foshan City (CN)

(73) Assignees: MITAC COMPUTER (SHUN DE) LTD., Foshan City (CN); MITAC INTERNATIONAL CORP., TAOYUAN COUNTY (TW)

(21) Appl. No.: 13/753,061

(22) Filed: Jan. 29, 2013

(30) Foreign Application Priority Data
Mar. 23, 2012 (CN) 201210080025.8

(51) Int. Cl. G06Q 50/30

(52) U.S. Cl. CPC G06Q 50/30; G06Q 10/0631
USPC 705/13

(57) ABSTRACT

The present invention discloses a passenger waiting system and a method thereof. The passenger waiting system comprises a transportation service demander device, a transportation service supplier device and a server. The transportation service demander device is used to provide a user to input the transportation demand to send a transportation demand message to the server. The transportation service supplier device is used to provide a service provider to input the transportation providing service to send a transportation supplying message to the server. The sever is used to compare the transportation demand message and the transportation supplying message to execute a supply-demand pairing task, and used to send the transportation demand message and the transportation supplying message to the transportation service supplier device and the transportation service demander device respectively for making the transportation service demander device can communicate with the transportation service supplier device.

### CROSS-REFERENCE TO RELATED APPLICATION

This application claims the benefit of China Patent Application No. 201210080025.8, filed on Mar. 23, 2012, in the State Intellectual Property Office of the People's Republic of China, the disclosure of which is incorporated herein in its entirety by reference.

### BACKGROUND OF THE INVENTION

1. Field of the Invention

The present invention relates to a passenger waiting system and a method thereof, and more particularly to the passenger waiting system and method wherein a passenger and service provider can use an electronic device with a GPS function to transmit a transportation demand and a transportation supply service to a server and performs a supply and demand pairing task by the server, so that the matched passenger and service provider can communicate with each other to conduct business transactions and negotiations.

2. Description of Related Art

At present, if a passenger wants to take a taxi, the traditional method is to wait for a taxi to pass by and wave for the taxi. However, the traditional method of calling a taxi that is passing by wastes time for both parties and even wastes gas.

Therefore, an on-call taxi service was introduced, and a passenger simply makes a call to a taxi company for the on-call taxi service, and inform the taxi company about the passenger's location and a desired destination location, so that the taxi company will use a one-to-many wireless communication method to assign a taxi nearest to the passenger to go to carry the passenger and informs the passenger about the car number and the expected arrival time. The on-call taxi service definitely overcomes the drawbacks of the traditional method of calling a taxi that is passing by. However, the on-call service generally requires the taxi company to ask the passenger some necessary information one by one, and the passenger has to answer these questions one by one, thus wasting the passenger's telephone charge, particularly for passengers calling a taxi by a cell phone.

In the aforementioned taxi calling methods, both passenger and taxi driver cannot accurate know about the transportation demand and the transportation supply service of both parties, thus resulting in time wasted in clarifying the demands before the ride. Therefore, the inventor of the present invention provides a passenger waiting system and a method thereof to overcome the aforementioned drawbacks.

### SUMMARY OF THE INVENTION

In view of the drawbacks of the aforementioned problems, it is a primary objective of the present invention to provide a passenger waiting system and a method thereof to overcome the drawbacks of the conventional taxi calling service that fails to provide quick and easy communication regarding the supply-and-demand service between the passenger and the taxi driver and causes time to be wasted.

To achieve the foregoing objective, the present invention provides a passenger waiting system comprising a transportation service demander device, a transportation service supplier device and a server. The transportation service demander device has first identification information and a GPS function, generates current location information based on the current position of the transportation service demander device, receives target location information and transportation information inputted by a user, and packages the first identification information, the current location information, the target location information and the transportation information as a transportation demand message to be transmitted. The transportation service supplier device, having second identification information and a GPS function, and packages second identification information, preset driving route information and transportation service information as a transportation supply message to be transmitted. The server is provided for receiving and comparing the transportation demand message and the transportation supply message to perform a supply and demand pairing, and transmitting the transportation demand message and the transportation supply message to the transportation service supplier device and the transportation service demander device respectively, such that the paired transportation service demander device and transportation service supplier device can communicate with each other by the first identification information and the second identification information.

Preferably, the transportation service demander device comprises a positioning module, an input module, a processing module and a transmitting module, and the positioning module positions the current position of the transportation service demander device to generate the current location information; the input module is provided for the user to input the target location information and the transportation information; the processing module is coupled to the positioning module and the input module to package the first identification information, the current location information, the target location information and the transportation information as the transportation demand message; and the transmitting module is coupled to the processing module to transmit the transportation demand message.

Preferably, after the server receives the transportation demand message and the transportation supply message, the preset driving route information in the transportation supply message and the current location information and the target location information in the transportation demand message are compared, and if at least one of the current location information and the target location information matches the preset driving route, the transportation supply message is transmitted to the transportation service demander device, and the transportation demand message is transmitted to the transportation service supplier device to complete a supply and demand pairing task.

Preferably, the first identification information and the second identification information include an internet protocol (IP) address, a media access control (MAC) address, a physical address or a telephone number.

Preferably, the transportation information includes a number of passengers and a quantity of carried goods.

Preferably, the transportation service information includes a capacity of passengers, a capacity of loaded goods, and a transportation fare.

Preferably, the transportation service supplier device transmits the transportation supply message containing current driving location information to the server, and if the current location information in the transportation demand message and the current driving location information in the transportation supply message are situated in a same regional area and the server performs a supply and demand pairing task.

Preferably, the transportation service demander device further comprises a display module for displaying the current driving location information of the transportation service, supplier device and the preset driving route information.

Preferably, the transportation service supplier device comprises a positioning module, an input module, a processing module, a transmitting module and a display module, and the positioning module positions the transportation service supplier device to generate the current driving location information; the input module is provided for a service provider to input the preset driving route information and the transportation service information; the processing module is coupled to the positioning module and the input module to package the second identification information, the preset driving route information and the transportation service information as the transportation supply message; the transmitting module is coupled to the processing module to transmit the transportation supply message; and the display module is coupled to the processing module to display the current location information of the transportation service demander device.

Preferably, the transportation service demander device and the transportation service supplier device separately include a communication module provided for the transportation service demander device and the transportation service supplier device to perform a voice or video communication.

Preferably, the server further stores the transportation demand message and the transportation supply message.

To achieve the aforementioned objective, the present invention further provides a passenger waiting method, comprising the steps of: providing a transportation service demander device having first identification information and a GPS function; generating current location information by the transportation service demander device based on the current position; using the transportation service demander device to receive target location information and transportation information inputted by a user; using the transportation service demander device to package the first identification information, the current location information, the target location information and the transportation information into a transportation demand message to be transmitted; providing a transportation service supplier device having second identification information and a GPS function; using the transportation service supplier device to package the second identification information, a preset driving route information and a transportation service information as a transportation supply message to be transmitted; providing a server to receive and compare the transportation demand message and the transportation supply message; performing a supply and demand pairing task by the server to transmit the transportation demand message and the transportation supply message to the transportation service supplier device and the transportation service demander device respectively, if the transportation demand message and the transportation supply message are matched; and performing a communication between the paired transportation service demander device and transportation service supplier device through the first identification information and the second identification information.

To achieve the aforementioned objective, the present invention further provides a passenger waiting method, comprising the steps of: issuing a transportation demand message according to the current position through a transportation service demander device; issuing a transportation supply message according to a driving location through a transportation service supplier device; receiving and comparing the transportation demand message and the transportation supply message through a server; and using the server to perform a supply and demand pairing task, and transmit the transportation demand message and the transportation supply message to the transportation service supplier device and the transportation service demander device respectively, if the transportation demand message matches the transportation supply message.

In summation, the passenger waiting system and method of the present invention have one or more of the following advantages:

(1) The passenger waiting system and method can be provided for a passenger to upload a transportation demand to a server, and for a service provider to upload a transportation supply service to the server, and the server performs a supply and demand pairing task and allows the passenger and the service provider to quickly and easily know of the demand and service supplied proposed respectively to reduce the waiting time during taking a transport.

(2) The passenger waiting system and method can use the satellite positioning method to let passenger find the nearest taxi with matched services provided at anytime and anywhere to reduce the waiting time. A taxi driver can select a place to park the vehicle or a driving route to look for target passengers according to the density of passengers to reduce the idling time.

### BRIEF DESCRIPTION OF THE DRAWINGS

FIG. 1 is a block diagram of a passenger waiting system of the present invention;

FIG. 2 is a flow chart of a passenger waiting method of the present invention;

FIG. 3 is another flow chart of a passenger waiting method of the present invention;

FIG. 4A is a first schematic view of a passenger waiting system and a method thereof in accordance with a preferred embodiment of the present invention;

FIG. 4B is a second schematic view of a passenger waiting system and a method thereof in accordance with a preferred embodiment of the present invention; and

FIG. 4C is a first schematic view of a passenger waiting system and a method thereof in accordance with a preferred embodiment of the present invention.

### DETAILED DESCRIPTION OF THE PREFERRED EMBODIMENTS

The technical contents and characteristics of the present invention will be apparent with the detailed description of a preferred embodiment accompanied with related drawings as follows. For simplicity, the same numerals are used for the same respective elements in the description of the following preferred embodiments and the illustration of the drawings.

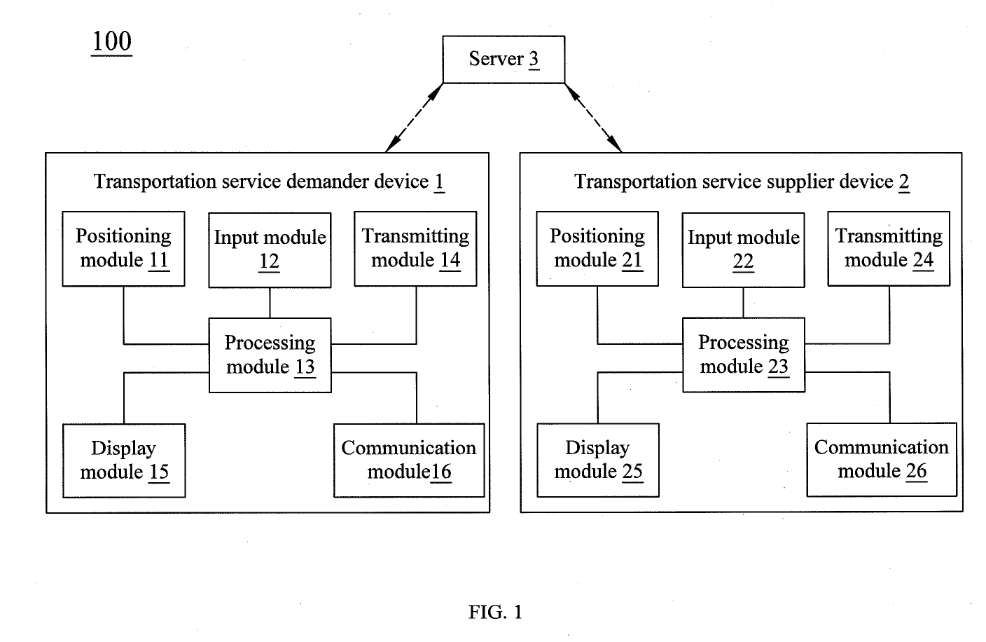

With reference to FIG. 1 for a block diagram of a passenger waiting system of the present invention, the passenger waiting system 100 comprises a transportation service demander device 1, a transportation service supplier device 2 and a server 3. The transportation service demander device 1 and the transportation service supplier device 2 can be electronic devices with a GPS function such as cell phones and personal digital assistants (PDA) and the transportation service demander device 1 and the transportation service supplier device 2 have first identification information and second identification information, wherein the first identification information and the second identification information can be international protocol (IP) addresses, media access control (MAC) addresses, physical addresses or telephone numbers used as an identification of the transportation service demander device 1 and the transportation service supplier device 2. The transportation service demander device 1 can be provided for the use by passengers, and the transportation service supplier device 2 can be installed in a vehicle such as a taxi. The server 3 can be a remote host, and the transportation service demander device 1 and the transportation service supplier device 2 can be connected to the server 3 via the Internet. The transportation service demander device 1 comprises a positioning module 11, an input module 12, a processing module 13, a transmitting module 14, a display module 15 and a communication module 16. The processing module 13 is coupled to the positioning module 11, the input module 12, the transmitting module 14, the display module 15 and the communication module 16. The transportation service supplier device 2 comprises a positioning module 21, an input module 22, a processing module 23, a transmitting module 24, a display module 25 and a communication module 26. The processing module 23 is coupled to the positioning module 21, the input module 22, the transmitting module 24, the display module 25 and the communication module 26. The input module 12, 22 can be a keypad and the display module 15, 25 can be a screen, wherein the input modules 12 and 22 and the display modules 15 and 25 can be touch screens.

In the description above, the positioning module 11 of the transportation service demander device 1 can be used for positioning the current location of the transportation service demander device 1 to generate current location information; the input module 12 is provided for a passenger to input target location information and transportation information, wherein the transportation information includes the number of passengers, the quantity of carried goods or a desired transportation time; the processing module 13 is provided for packaging the first identification information, the current location information, the target location information and the transportation information as a transportation demand message; the transmitting module 14 is used to transmit the transportation demand message to the server 3. The positioning module 21 of the transportation service supplier device 2 is provided for positioning the transportation service supplier device 2 to generate current driving location information; the input module 22 is provided for a taxi driver or a service provider of a taxi company to input preset driving route information and transportation service information, wherein the preset driving route information can set a destination only or a plurality routes to the destination, and the transportation service information includes a capacity of passengers, a capacity of loaded goods, and a ride fare; the processing module 23 is provided for packaging the second identification information, the current driving location information, the preset driving route information and the transportation service information as a transportation supply message; the transmitting module 24 is provided for transmitting the transportation supply message to the server 3. When the server 3 receives the transportation demand message and the transportation supply message, a comparison is carried out to compare the transportation demand message with the transportation supply message. If the transportation demand message matches the transportation supply message, the server 3 will carry out a supply and demand pairing task to transmit the transportation supply message to the transportation service demander device 1, and transmit the transportation demand message to the transportation service supplier device 2, such that the transportation service demander device 1 can connect to the transportation service supplier device 2 based on the second identification information, and the transportation service supplier device 2 can connect the transportation service demander device 1 through the first identification information, such that communications can be carried out between the transportation service demander device 1 and the transportation service supplier device 2 to let passengers and service providers carry out business transactions and negotiations. When the server 3 compares the transportation demand message with the transportation supply message, the current location information and the target location information in the transportation demand message are compared with the preset driving route in the transportation supply message. If the current location information and the target location information fall within the preset driving route, then they are considered to be matched with each other, and the server will carry out the supply and demand pairing task, or the server 3 will compare the current location information in the transportation demand message with the current driving location information in the transportation supply message. If the current location information and the current driving location information are situated in the same regional area, the server 3 will carry out the supply and demand pairing task. If the server 3 compares the transportation information (such as the number of passengers, the quantity of carried goods, the passenger's desired transportation time or the passenger's affordable transportation fare) in the transportation demand message with the transportation service information (such as the capacity of passengers, the capacity of loaded goods or the transportation fare) in the transportation supply message. If they match, then the supply and demand pairing task will be carried out. The aforementioned comparison methods are used for illustrating the present invention only, and are not intended for limiting the scope of the invention.

In the description above, after the server 3 receives the transportation demand message and the transportation supply message, the server 3 stores them as a record. When the transportation service demander device 1 and the transportation service supplier device 2 are connected for communication, both devices 1, 2 can perform a voice or video communication with each other through communication modules 16 and 26 or can transmit texts or figures through transmitting modules 14 and 24. In addition, the display module 15 of the transportation service demander device 1 is provided for displaying the current driving location information, the preset driving route information of the transportation service supplier device 2 or their combination to inform the passenger about the current location and the driving route of the taxi from the map. The display module 25 of the transportation service supplier device 2 is provided for displaying the current location information of the transportation service demander device 1 to inform a taxi service provider about the passenger's present location from the map.

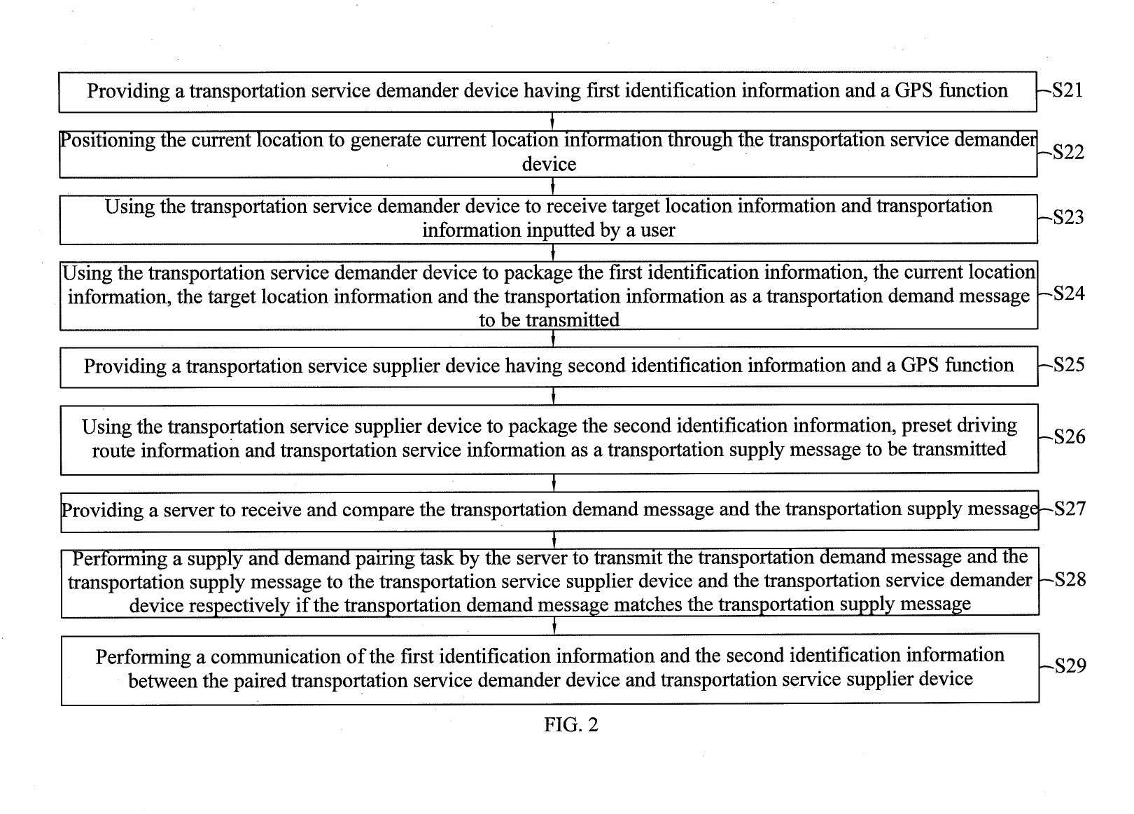

With reference to FIG. 2 for a flow chart of a passenger waiting method of the present invention, the method comprising the following steps:

S21: Providing a transportation service demander device having first identification information and a GPS function.

S22: Positioning the current location to generate current location information through the transportation service demander device.

S23: Using the transportation service demander device to receive target location information and transportation information inputted by a user.

S24: Using the transportation service demander device to package the first identification information, the current location information, the target location information and the transportation information as a transportation demand message to be transmitted.

S25: Providing a transportation service supplier device having second identification information and a GPS function.

S26: Using the transportation service supplier device to package the second identification information, preset driving route information and transportation service information as a transportation supply message to be transmitted.

S27: Providing a server to receive and compare the transportation demand message and the transportation supply message.

S28: Performing a supply and demand pairing task by the server to transmit the transportation demand message and the transportation supply message to the transportation service supplier device and the transportation service demander device respectively if the transportation demand message matches the transportation supply message.

S29: Performing a communication of the first identification information and the second identification information between the paired transportation service demander device and transportation service supplier device.

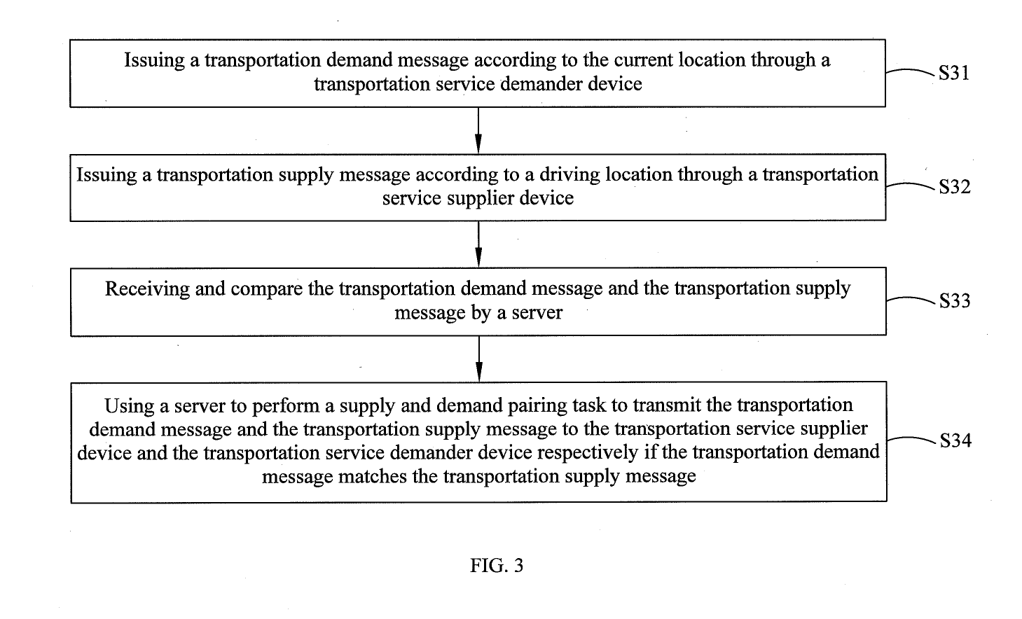

With reference to FIG. 3 for another flow chart of a passenger waiting method of the present invention, the method comprises the following steps:

S31: Issuing a transportation demand message according to the current location through a transportation service demander device.

S32: Issuing a transportation supply message according to a driving location through a transportation service supplier device.

S33: Receiving and comparing the transportation demand message and the transportation supply message by a server.

S34: Using a server to perform a supply and demand pairing task to transmit the transportation demand message and the transportation supply message to the transportation service supplier device and the transportation service demander device respectively if the transportation demand message matches the transportation supply message.

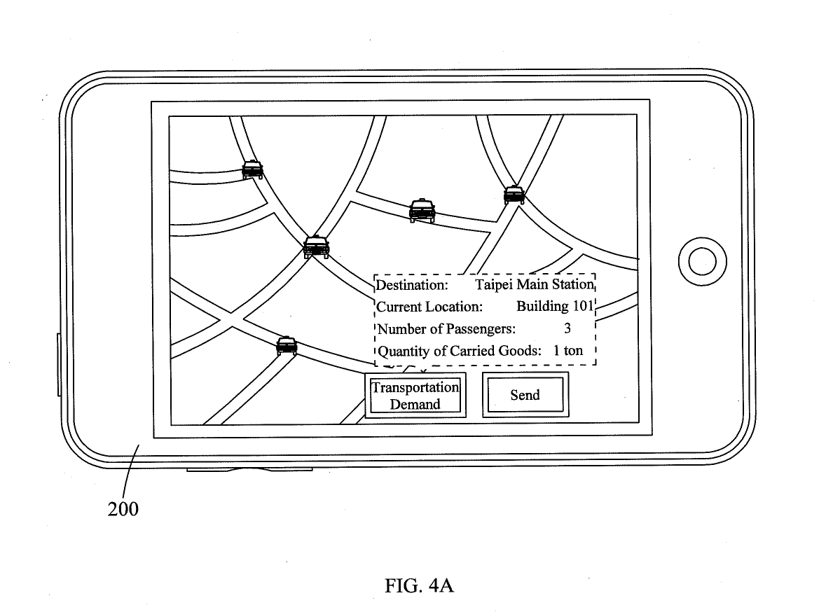

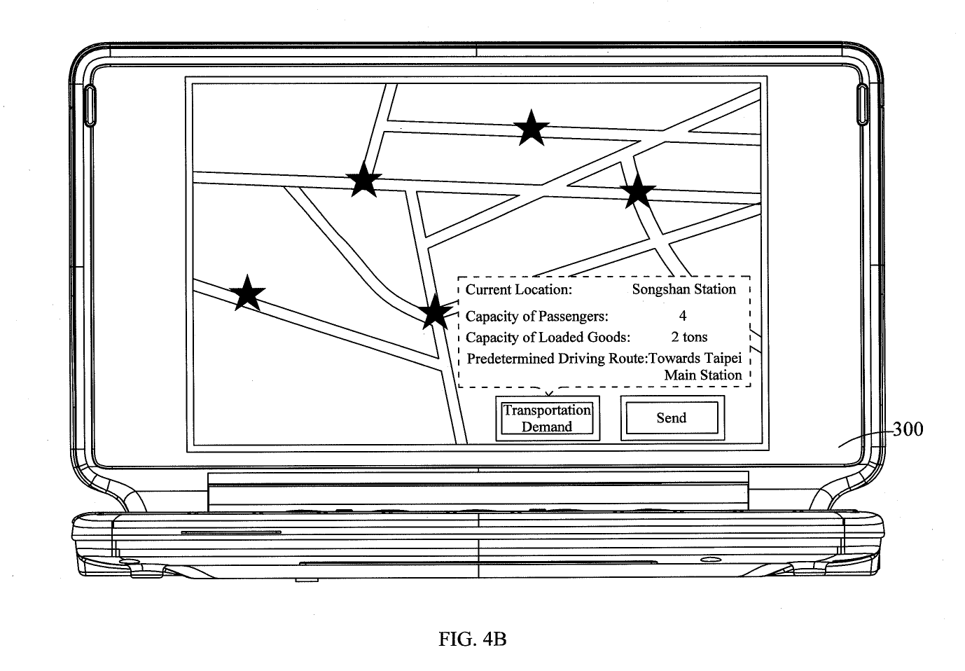

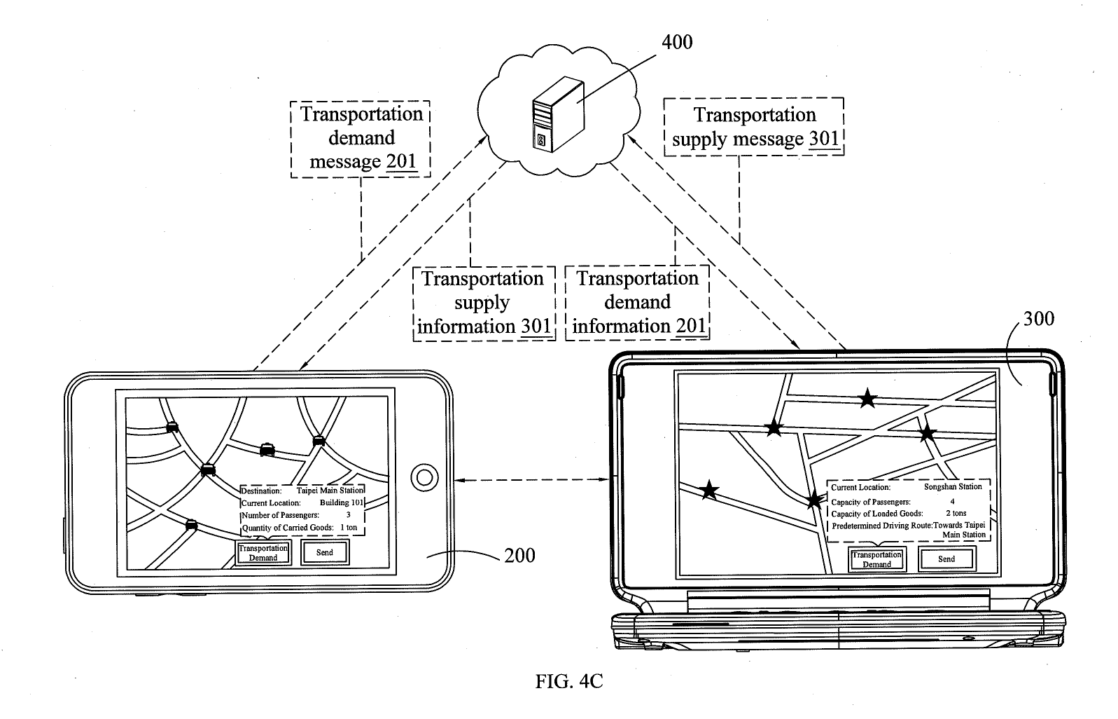

With reference to FIG. 4A, 4B and 4C for the first, second and third schematic views of a passenger waiting system and a method thereof in accordance with a preferred embodiment of the present invention respectively, a transportation service demander device 200 is provided for the use by a passenger. If the passenger wants to take a ride, one of the transportation demand press keys can be used to input a transportation demand, and the transportation demand in an embodiment is set to a destination of “Taipei Main Station”, the current location of “Building 101”, the number of passengers equal to 3, and the quantity of carried goods equal to “1 ton” as shown in FIG. 4A. Wherein, the current location can be inputted by a passenger or automatically obtained from a satellite positioning by the transportation service demander device 200. In an embodiment, a transportation service supplier device 300 can be installed in a taxi and provided for a taxi driver to input a transportation service supply service inputted from the service supply press key, and the transportation supply service is set to the current location of “Songshan Station”, the capacity of passengers equal to 4, the capacity of loaded goods equal to 2 tons, the preset driving route of “towards Taipei Main Station” as shown in FIG. 4B. Wherein, the current location of “Songshan Station” can be inputted by the driver or automatically obtained by a satellite positioning method through the transportation service supplier device 300. If the passenger and the taxi driver use the keypad of the transportation service demander device 200 and the transportation service supplier device 300 to transmit the transportation demand message 201 including the transportation demand of “Taipei Main Station”, “Building 101”, “3 persons” and “one tone” transportation demand and the transportation supply message 301 including the transportation supply service including “Songshan Station”, “4 persons”, “2 tons” and “Towards Taipei Main Station” to a server 400 respectively, then the server 400 will start comparing the transportation demand message 201 and the transportation supply message 301 to determine whether the conditions of the transportation demand message 201 and the transportation supply message 301 match with one another; if yes, then the server 400 will send the transportation supply message 301 to the transportation service demander device 200 and will transmit the transportation demand message 201 to the transportation service supplier device 300. When the transportation service demander device 200 and the transportation service supplier device 300 transmit the transportation demand message 201 and the transportation supply message 301 respectively, the identification information such as an IP address, a MAC address, a physical address or a telephone number will be transmitted as well, so that when the transportation service demander device 200 and the transportation service supplier device 300 receive the transportation supply message 301 and the transportation demand message 201 respectively, the aforementioned identification information can be used for communication for business transactions and negotiations as shown in FIG. 4C. Wherein, the passenger waiting system of the present invention not only limits to the comparison and communication of one transportation service demander device 200 with one transportation service supplier device 300, and the server 3 can compare the transportation demand message 201 with the transportation supply message 301 uploaded by several transportation service demander devices 200 and several with several transportation service supplier devices 300, such that the passenger can obtain several transportation supply messages 301 that match the transportation demand and select one of the taxi drivers for business transactions and negotiations. The taxi drivers can obtain several transportation demand messages 201 that match the drivers' transportation supply services, such that the taxi drivers can search more potential customers according to their driving route.

In the description above, the transportation service demander device 200 can display the location of each transportation service supplier device 300, and allow a passenger to know the movements of all taxis within a regional area at a glance. Similarly, the transportation service supplier device 300 can show the location of each transportation service demander device 200 to let taxi drivers see the passenger's desired transportation location.

In summation of the description above, the present invention breaks through the prior art and achieve the expected objectives, and complies with the patent application requirements, and thus is duly filed for patent application.

What is claimed is:

1. A passenger waiting system, comprising:
a transportation service demander device, having first identification information and a GPS function, generating current location information based on the current position of the transportation service demander device, receiving target location information and transportation information inputted by a user, and packaging the first identification information, the current location information, the target location information and the transportation information as a transportation demand message to be transmitted;
a transportation service supplier device, having second identification information and a GPS function, and packaging the second identification information, preset driving route information and transportation service information as a transportation supply message to be transmitted; and
a server, for receiving and comparing the transportation demand message and the transportation supply message to perform a supply and demand pairing task, and transmitting the transportation demand message and the transportation supply message to the transportation service supplier device and the transportation service demander device respectively, such that the paired transportation service demander device and transportation service supplier device communicate with each other by the first identification information and the second identification information.

2. The passenger waiting system of claim 1, wherein the transportation service demander device comprises a positioning module, an input module, a processing module and a transmitting module, and the positioning module positions the current position of the transportation service demander device to generate the current location information; the input module is provided for the user to input the target location information and the transportation information; the processing module is coupled to the positioning module and the input module to package the first identification information, the current location information, the target location information and the transportation information as the transportation demand message; and the transmitting module is coupled to the processing module to transmit the transportation demand message.

3. The passenger waiting system of claim 1, wherein after the server receives the transportation demand message and the transportation supply message, the preset driving route information in the transportation supply message and the current location information and the target location information in the transportation demand message are compared, and if at least one of the current location information and the target location information matches the preset driving route, the transportation supply message is transmitted to the transportation service demander device, and the transportation demand message is transmitted to the transportation service supplier device to complete a supply and demand pairing task.

4. The passenger waiting system of claim 1, wherein the first identification information and the second identification information include an internet protocol (IP) address, a media access control (MAC) address, a physical address or a telephone number.

5. The passenger waiting system of claim 1, wherein the transportation information includes a number of passengers and a quantity of carried goods.

6. The passenger waiting system of claim 1, wherein the transportation service information includes a capacity of passengers, a capacity of loaded goods, and a ride fare.

7. The passenger waiting system of claim 1, wherein the transportation service supplier device transmits the transportation supply message containing current driving location information to the server, and if the current location information in the transportation demand message and the current driving location information in the transportation supply message are situated in a same regional area, the server performs the supply and demand pairing task.

8. The passenger waiting system of claim 7, wherein the transportation service demander device further comprises a display module for displaying the current driving location information of the transportation service supplier device and the preset driving route information.

9. The passenger waiting system of claim 7, wherein the transportation service supplier device comprises a positioning module, an input module, a processing module, a transmitting module and a display module, and the positioning module positions the transportation service supplier device to generate the current driving location information; the input module is provided for a service provider to input the preset driving route information and the transportation service information; the processing module is coupled to the positioning module and the input module to package the second identification information, the preset driving route information and the transportation service information as the transportation supply message; the transmitting module is coupled to the processing module to transmit the transportation supply message; and the display module is coupled to the processing module to display the current location information of the transportation service demander device.

10. The passenger waiting system of claim 1, wherein the transportation service demander device and the transportation service supplier device separately include a communication module provided for the transportation service demander device and the transportation service supplier device to perform a voice or video communication.

11. The passenger waiting system of claim 1, wherein the server further stores the transportation demand message and the transportation supply message.

12. A passenger waiting method, comprising the steps of:
providing a transportation service demander device having first identification information and a GPS function;
generating current location information by the transportation service demander device based on the current position;
using the transportation service demander device to receive target location information and transportation information inputted by a user;
using the transportation service demander device to package the first identification information, the current location information, the target location information and the transportation information into a transportation demand message to be transmitted;
providing a transportation service supplier device having second identification information and a GPS function;
using the transportation service supplier device to package the second identification information, a preset driving route information and a transportation service information as a transportation supply message to be transmitted;
providing a server to receive and compare the transportation demand message and the transportation supply message;
performing a supply and demand pairing task by the server to transmit the transportation demand message and the transportation supply message to the transportation service supplier device and the transportation service demander device respectively, if the transportation demand message and the transportation supply message are matched; and
performing a communication between the paired transportation service demander device and transportation service supplier device through the first identification information and the second identification information.

13. The passenger waiting method of claim 12, wherein after the server receives the transportation demand message and the transportation supply message, the preset driving route information in the transportation supply message and the current location information and the target location information in the transportation demand message are compared, and if at least one of the current location information and the target location information matches the preset driving route, the transportation supply message is transmitted to the transportation service demander device, and the transportation demand message is transmitted to the transportation service supplier device to complete the supply and demand pairing task.

14. The passenger waiting method of claim 12, further comprising the steps of: driving the transportation service supplier device to transmit the transportation supply message containing a current driving location information to the server; and if the current location information in the transportation demand message and the current driving location information in the transportation supply message are situated in a same regional area, the server performs the supply and demand pairing task.

15. The passenger waiting method of claim 14, further comprising the steps of: displaying the current driving location information and the preset driving route information of the transportation service supplier device through the transportation service demander device.

16. A passenger waiting method, comprising the steps of:
issuing a transportation demand message according to a current position through a transportation service demander device;
issuing a transportation supply message according to a driving location through a transportation service supplier device;
receiving and comparing the transportation demand message and the transportation supply message through a server; and
using the server to perform a supply and demand pairing task, and transmit the transportation demand message and the transportation supply message to the transportation service supplier device and the transportation service demander device respectively, if the transportation demand message matches the transportation supply message.

17. The passenger waiting method of claim 16, wherein the transportation service demander device and the transportation service supplier device displays position information of one another after being paired.
